(19) United States
(12) Patent Application Publication
(10) Pub. No.: US 2025/0229580 A1
(43) Pub. Date: Jul. 17, 2025

(54) DEVICE AND METHOD FOR A HIGH AIR FLOW VALVE STEM PLUG

(71) Applicant: Sandy Ochoa, Alamogordo, NM (US)

(72) Inventor: Sandy Ochoa, Alamogordo, NM (US)

(21) Appl. No.: 18/930,116

(22) Filed: Oct. 29, 2024

Related U.S. Application Data
(60) Provisional application No. 63/546,413, filed on Oct. 30, 2023.

(51) Int. Cl. B60C 29/00

(52) U.S. Cl. CPC B60C 29/005

(57) ABSTRACT

The present invention is a high air flow valve stem plug that provides a better and more efficient way to inflate large tires, such as those used in the agricultural industry, off-road vehicles, and mining tires. The device comprises a plug having a plurality of female threads located on the interior surface of one end and an unrestricted bore running completely through, the plug. It is a compact large bore plug designed to deliver a maximum unrestricted airflow to the valve stem of large tires. It is attached and removed by hand, eliminating the need for additional tools. The exterior surface of the plug is textured so that it is not smooth or slippery to the touch.

### CROSS-REFERENCE TO RELATED APPLICATIONS

This application claims priority to and benefit of the filing of U.S. Provisional Patent Application Ser. No. 63/546,413 filed on Oct. 30, 2023, entitled “Device and Method for a High Flow Coupler Nipple Plug” and the specification thereof is incorporated here by reference.

### BACKGROUND OF THE INVENTION

There is a need for a better and more efficient way to inflate large tires, such as those used in the agricultural industry, off-road vehicles, and mining tires. Currently, valves for large tires are connected to standard, small air supply devices, which severely restrict the air flow. Attempting to fill one of these large tires the same way as you would a passenger vehicle tire is not practical and takes too much time.

Additionally, the current devices used to fill these large tires are comprised of two or more pieces, making them more time-consuming, cumbersome, and prone to failure. Also, many of them require additional tools in order to attach to a tire valve.

Another factor in the usefulness of a tire valve inflation device is the number of threads inside the nipple. Too many threads just add more time to the installation.

For instance, U.S. Pat. No. 11,046,128 discloses a valve adapter that connects to a valve stem, having an air passage and a valve core that allows air to be injected into the tire as the valve body is pressed down toward the tire. A seal is also provided to prevent the air from leaking.

And U.S. Pat. No. 8,196,615 discloses a liquid/air pressure testing tool with a valving arrangement to allow alternating fluid transfer and air backfilling of a fluid-filled agricultural tire. There is an inline ball valve and an isolation valve, which allows monitoring of internal tire pressure using a common pressure gauge.

Canadian Patent No. 1089342 discloses an adaptor for vehicle tire valve stems that has quick connect and disconnect connectors.

Finally, U.S. Pat. No. 5,305,784 discloses a tire inflation hose assembly for interconnecting a container of pressurized tire inflation material with a tire valve stem. That includes a connected release valve assembly for releasing the pressurized material contained therein. A flexible tube transports the released material to a nozzle which is adaptable for mating with the valve stem of the tire such that the pressurized material enters the tire when released by the release valve assembly. A pair of transverse pins secure the tube to the nozzle and the release valve assembly.

As shown below, none of the prior art offers the benefits of the present invention.

### BRIEF SUMMARY OF THE INVENTION

The present invention is a novel high air flow valve stem plug. The novelty of this design is to deliver a maximum, unrestricted, airflow through a large bore plug attached to a valve stem of a large tire, such as an off-road vehicle, tractor, or loader. It is compact and low profile and designed to be easily attached and removed from a valve stem, even in areas with limited space.

The device of the present invention is a high air flow valve stem plug comprising a plug having a first end and a second end and an interior surface and an exterior surface. There are a plurality of female threads located on the interior surface of the first end, and an unrestricted bore, or tunnel, of constant diameter located within, and running completely through, the plug.

The section of the first end of the plug has an exterior diameter that is larger than the section of the second end. Also, the exterior surface of the section of the first end of the plug is textured so that it is not smooth or slippery to the touch. Preferably it is knurled. This section of the first end of the plug can be round, square, or hexagonal.

In the preferred embodiment, the diameter of the bore is at least ⅜ of an inch. The large, uniform size of the bore allows a large volume of air to flow through the device into the tire in an unrestricted manner. This allows the large tire to fill much more quickly than a standard passenger vehicle valve stem plug.

Also preferable, the plurality of female threads located on the interior surface of the first end should number 5, 6, or 7. The lower-than-standard number of threads make attachment of the device to a valve stem occur much more quickly.

The valve stem plug is preferably made of cold rolled carbon steel. Cold rolled steel undergoes an additional rolling process that increases strength and durability. Among other things, this high strength construction prevents galling or damaging of the threads of the plug or the valve stem.

As used herein, certain terms have the following definitions:

A “bore” is a tunnel running the length of a piece of pipe.

“Knurled” means having small ridges or a pattern of raised elements on a surface.

A “groove” is a long, narrow depression, especially one made to receive a corresponding ridge.

### BRIEF DESCRIPTION OF THE DRAWINGS

FIG. 1 is a perspective view of the present invention.

FIG. 2 is a side view of the present invention.

FIG. 3 shows the present invention about to be attached to a valve stem.

FIG. 4 shows the present invention attached to a valve stem.

FIG. 5 shows an air supply hose about to be attached to the present invention.

FIG. 6 shows an air supply hose attached to the present invention, which is attached to a valve stem.

FIG. 7 shows the plurality of female threads located on the interior surface of the present invention.

### DETAILED DESCRIPTION OF THE DRAWINGS

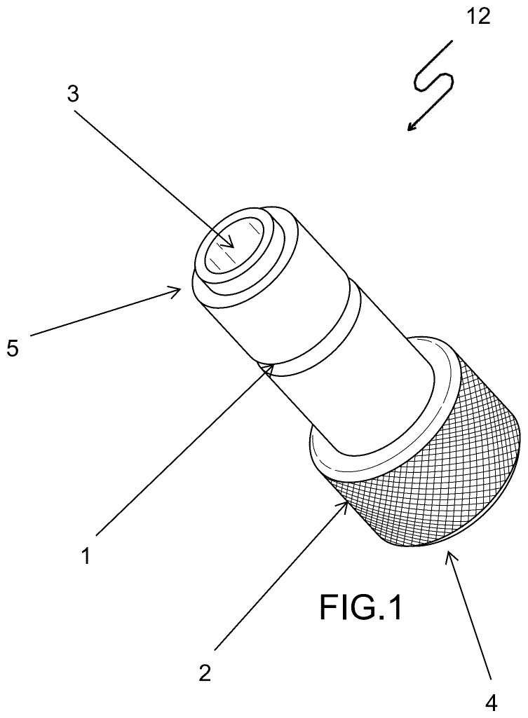

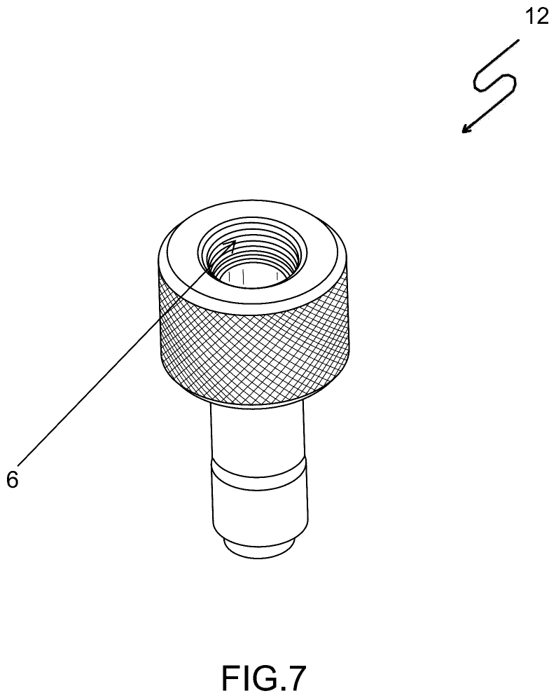

FIG. 1 shows the high air flow valve stem plug 12 of the present invention comprising a plug 12 having a first end 4 and a second end 5 and an interior surface and an exterior surface. There are a plurality of female threads 6 (see FIG. 7) located on the interior surface of the first end and an unrestricted bore 3 of constant diameter located within, and running completely through, the plug 12.

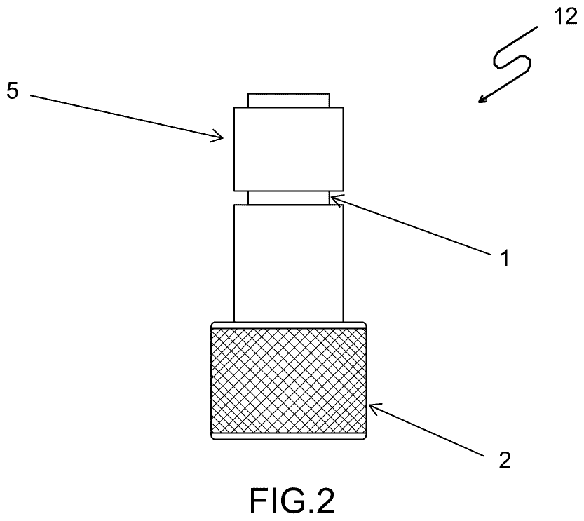

FIG. 2 shows the high air flow valve stem plug 12 of the present invention where a section of the first end 4 of the plug has an exterior diameter that is larger than the exterior diameter of the section of the second end 5. The exterior surface of the section of the first end 4 of the plug is textured. Also shown is a groove 1 that is located on the exterior surface of the section of the second end 5 of the plug in order to receive an air supply hose connector.

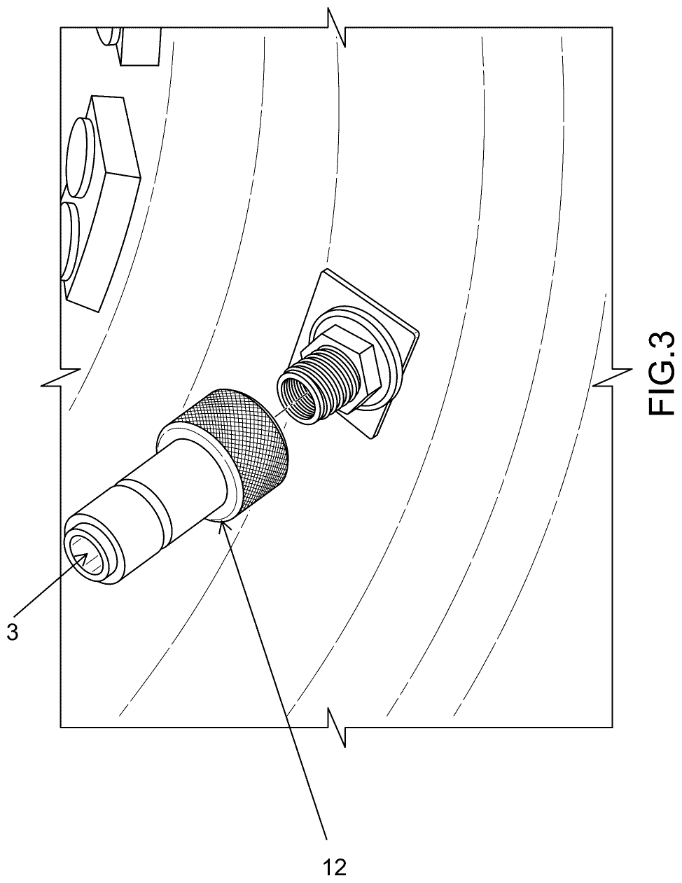

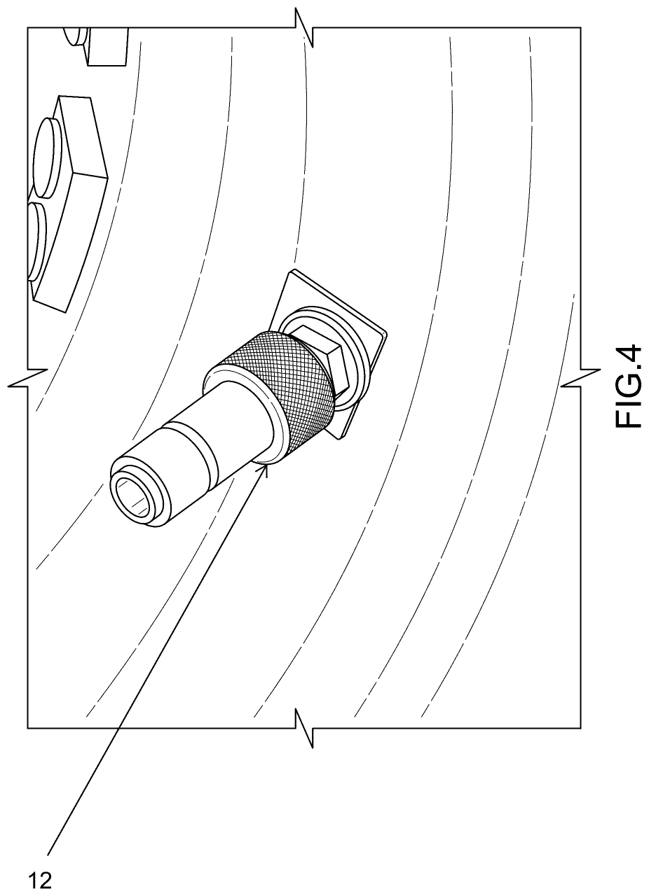

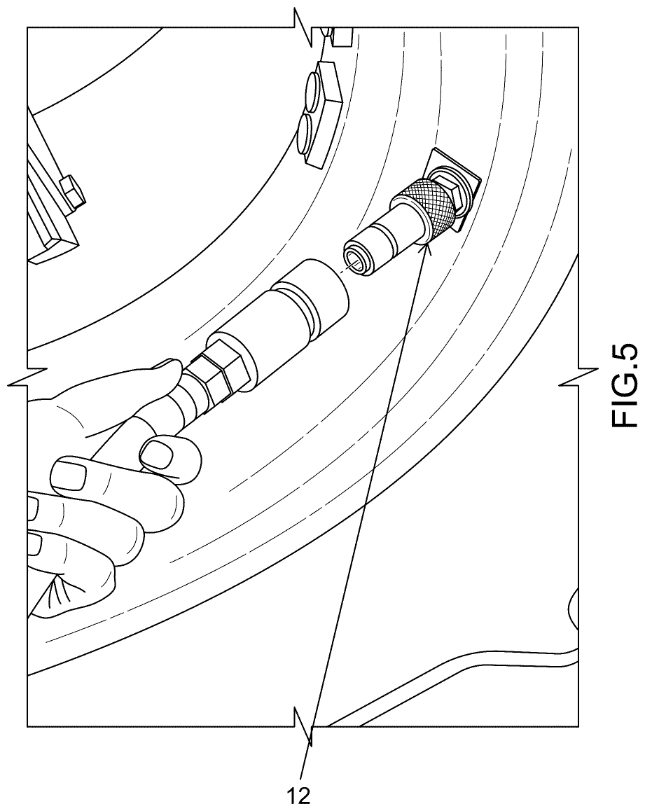

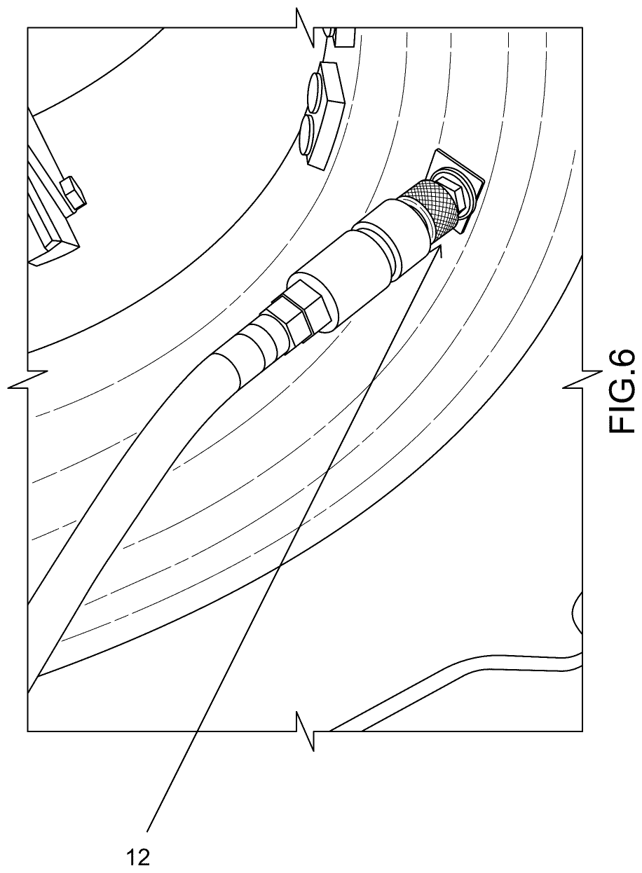

FIGS. 3, 4, 5 and 6 show the present invention being attached to a valve stem and an air supply hose.

FIG. 7 shows the high air flow valve stem plug 12 of the present invention including the plurality of female threads 6 located on the interior surface of the first end.

Whereas the figures and descriptions have illustrated and described the concept and preferred embodiment of the present invention, it should be apparent to those skilled in the art that various changes may be made in the form of the invention without affecting the scope thereof. The detailed description above is not intended in any way to limit the broad features or principles of the invention, or the scope of the patent monopoly granted.

I claim:

1. A high air flow valve stem plug comprising:
a. a plug having a first end and a second end and an interior surface and an exterior surface;
b. a plurality of female threads located on the interior surface of the first end; and
c. an unrestricted bore of constant diameter located within, and running completely through, the plug.

2. The high air flow valve stem plug of claim 1 wherein a section of the first end of the plug has an exterior diameter that is larger than the exterior diameter of a section of the second end.

3. The high air flow valve stem plug of claim 1 wherein the exterior surface of the section of the first end of the plug is textured.

4. The high air flow valve stem plug of claim 1 wherein the diameter of the bore is at least ⅜ of an inch.

5. The high air flow valve stem plug of claim 1 wherein the plurality of female threads located on the interior surface of the first end number 5, 6, or 7.

6. The high air flow valve stem plug of claim 1 wherein a groove is located on the exterior surface of the section of the second end of the plug to receive an air supply hose connector.
